(19) United States
(12) Patent Application Publication
(10) Pub. No.: US 2011/0137875 A1
(43) Pub. Date: Jun. 9, 2011

(54) INCREMENTAL MATERIALIZED VIEW REFRESH WITH ENHANCED DML COMPRESSION

(75) Inventors: Mohamed Ziauddin, Pleasanton, CA (US); Andrew Witkowski, Foster City, CA (US)

(73) Assignee: ORACLE INTERNATIONAL CORPORATION, REDWOOD SHORES, CA (US)

(21) Appl. No.: 12/634,641

(22) Filed: Dec. 9, 2009

(51) Int. Cl. G06F 17/00

(52) U.S. Cl. 707/693; 707/E17.007

(57) ABSTRACT

An incremental refresh of a materialized view may be simplified, and therefore made more cost efficient, by reducing the number of DML operations being merged with the materialized view during the incremental refresh. Specifically, subsequences of sequences of data manipulation language operations that have been recorded for a particular row of a base table may be inspected to determine whether the subsequences conform to particular patterns of data manipulation language operator types. If a subsequence conforms to one of the particular patterns, the subsequence may be replaced with a single substitute: either a single data manipulation language operation, or null. Refresh operations that are generated based on the simplified sequences of data manipulation language operations are more simple, and therefore, less costly to perform.

### FIELD OF THE INVENTION

The present invention relates to refreshing a materialized view, and specifically to compressing DML operations during an incremental materialized view refresh.

### BACKGROUND

In a database management system (“database system”), data is stored in one or more data containers, each container contains records, and the data within each record is organized into one or more fields. In relational database systems, the data containers are referred to as tables, the records are referred to as rows, and the fields are referred to as columns. In object oriented databases, the data containers are referred to as object classes, the records are referred to as objects, and the fields are referred to as attributes. Other database architectures may use other terminology.

The present invention is not limited to any particular type of data container or database architecture. However, for the purpose of explanation, the examples and the terminology used herein shall be that typically associated with relational databases. Thus, the terms “table”, “row” and “column” shall be used herein to refer respectively to the data container, record, and field.

In a database used for “data warehousing” or “decision support”, etc., it is common for identical or closely related queries to be issued frequently. For example, a business may periodically generate reports that summarize the business facts stored in the database, such as: “What have been the best selling brands of soft drinks in each of our sales regions, during the past six months?”.

To respond to such queries, the database server typically has to perform numerous join operations, aggregation operations, etc. The join operations may be performed because the database records that contain the information that is required to respond to the queries are organized into more than one database table. The aggregation operations may be performed to compute overall figures that involve part or all of the information in one or more columns of the base tables.

### Materialized Views

When a database system contains very large amounts of data, certain queries against the database can take an unacceptably long time to execute. Among commercial users of database systems, it has become a common practice to store the results of often-repeated queries in database tables or some other persistent database object. By storing the results of queries, the costly operations required to generate the results do not have to be performed every time the queries are issued. Rather, the database server responds to the queries by simply retrieving the pre-computed data.

These stored results are commonly referred to as materialized views. The contents of a materialized view is defined by metadata referred to as a view definition. The view definition contains mappings to one or more columns in the one or more tables containing the data. Typically, the view definition is in the form of a database query.

Columns and tables that are mapped to a materialized view are referred to herein as base columns and base tables of the materialized view, respectively. The column of a materialized view and the base column mapped to the column are referred to as being the same field.

Materialized views eliminate the overhead associated with gathering and deriving the data every time a query is executed. Computer database systems that are used for data warehousing frequently maintain materialized views that contain pre-computed joins and/or summary information in order to speed up query processing. Storing materialized views may be costly, but the storage cost may be offset by the gains of having the pre-computed query at hand.

Summary information is created by applying an aggregate function, such as SUM, COUNT, or AVERAGE, to values contained in the base tables. An example of aggregated information may be “sum of product_sales, by region, by month.” Other examples of aggregated information include counts of tally totals, minimum values, maximum values, and average calculations.

### Refreshing Materialized Views

As new data is periodically added to the base tables of a materialized view, the materialized view needs to be updated to reflect the new base data. When a materialized view accurately reflects all of the data currently in its base tables, the materialized view is considered to be “fresh”. Otherwise, the materialized view is considered to be “stale”. A stale materialized view may be recomputed by various techniques that are collectively referred to as “refresh”.

One approach to refreshing materialized views is referred to as the “total refresh” or “complete refresh” approach. According to the complete refresh approach, during each refresh operation, all values stored in a stale materialized view are discarded and recalculated based on all of the base data. Systems that employ the complete refresh approach have the disadvantage that the re-creation process is a relatively lengthy operation due to the size and number of tables from which the materialized data is derived. For example, when ten new rows are added to a particular base table that contains a million rows, a complete refresh operation would have to process all one million and ten rows of the base table to regenerate the materialized views derived using the base table.

The process of updating materialized data may be improved by performing an incremental refresh, where rather than generating a new set of materialized data based on calculations that use all of the base data, the materialized data is updated based on just the new base data (i.e., the changes made to the base tables subsequent to the most recent refresh operation). New base data may be tracked using materialized view logs (“MV logs”) that are maintained for each of the base tables of a materialized view to track changes made to the base tables.

An MV log may be stored in a queriable database object, such as a database table. The changes tracked in the MV logs associated with the base tables of a materialized view may be applied to the materialized view to refresh the view. If the number of tracked changes is relatively few, the cost of performing the incremental refresh may be relatively low. However, if there are many changes to be applied to the materialized view, the incremental refresh operation may have a high cost. Therefore, it is beneficial to minimize the number of changes applied to a materialized view during an incremental refresh operation.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example MV log for a base table of a materialized view.

FIG. 2 illustrates a table delta based on change information extracted from an MV log.

FIG. 3 illustrates an example method for logically compressing DML operations tracked in a table delta.

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An incremental refresh of a materialized view may be simplified, and therefore made more cost efficient, by reducing the number of DML operations being merged with the materialized view during the incremental refresh. Specifically, subsequences of sequences of data manipulation language operations that have been recorded for a particular row of a base table may be inspected to determine whether the subsequences conform to particular patterns of data manipulation language operator types. If a subsequence conforms to one of the particular patterns, the subsequence may be replaced with a single substitute: either a single data manipulation language operation, or null. Refresh operations that are generated based on the simplified sequences of data manipulation language operations are more simple, and therefore, less costly to perform.

### Tracking Changes in the Materialized View Logs

To perform incremental refresh operations on a materialized view, a database system tracks changes to base tables of a materialized view in MV logs for the base tables. The database system extracts those changes stored in the MV logs for the base tables of the materialized view, and then applies the extracted changes to the materialized view. Each base table of a materialized view is associated with a single MV log that is used to track the changes to the corresponding base table.

Changes to base tables may be performed using data manipulation language (DML) operations, which include DML operators such as “insert”, “delete”, and “update”. These operators facilitate adding new rows of data into database objects (“insert”), changing column values in existing rows of database objects (“update”), and removing rows from database objects (“delete”), etc. A database object may be a database table, or a database view, etc.

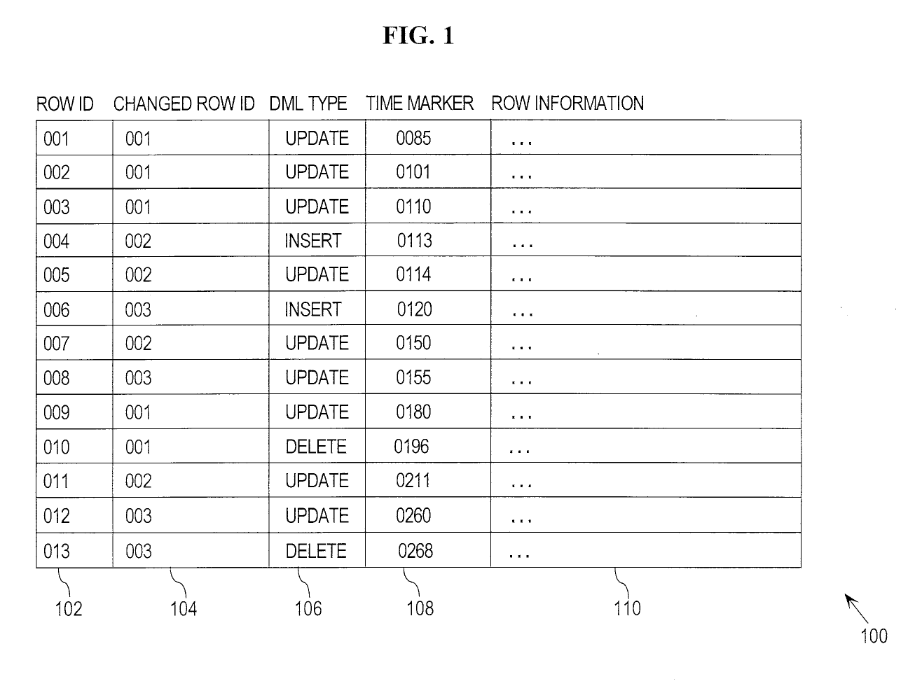

An MV log may be stored in a database table, where a row of the table represents one change event in the corresponding base table. As previously indicated, a change event may be a single DML operation performed on the base table. Changes to the base tables of a materialized view may be tracked in ways other than MV logs within the embodiments of the invention. An example MV log 100 for a base table of a particular materialized view is illustrated in FIG. 1. Log 100 includes columns 102-110: row identifier column 102, changed row identifier column 104, DML type column 106, time marker column 108, and row information column 110. MV logs may have different configurations of information within the embodiments of the invention.

Row identifier column 102 includes unique identifiers for each of the rows of MV log 100. Changed row identifier column 104 includes a row identifier that identifies the row in the base table that was changed by the tracked DML operation. Thus, MV log 100 includes information for various DML operations that have operated on the rows in the corresponding base table corresponding to row identifiers “001”, “002”, and “003”. For ease of illustration, these rows are referred to as row “001”, row “002”, and row “003”, respectively.

DML type column 106 indicates the type of DML operator that effectuated the recorded change. Time marker column 108 includes an indication of the time, or time marker, at which the recorded change occurred. A time marker may be a time stamp, or a unique number that is assigned to each change as the change is committed to the base table, etc. In the example of MV log 100, time marker column 108 includes numbers that infer the time at which each change occurred.

Row information column 110 includes a record of the change made to the changed row in the base table. For example, for an “update” type DML operation, row information column 110 may include an image of the changed row before the update and an image of the changed row after the update. For an “insert” type DML operation, row information column may include an image of the row that was inserted into the base table. Further, for a “delete” type DML operation, row information column 110 may include an image of the row that was deleted from the base table.

A DML operation performed on a base table of a materialized view may be recorded in the corresponding MV log upon committing the transaction that performs the operation. To illustrate, an example materialized view represents a join between base tables S and T on T.c=S.c. A transaction is initiated that inserts a row into table S. Upon committing the transaction, the database system records the “insert” type DML operation performed on table S in an MV log that corresponds to table S. Specifically, a copy of the row image that was inserted into table S is included in the MV log for table S, along with the DML operation type, a time marker that reflects the time that the transaction was committed, and the row identifier for the inserted row into table S.

### Table Deltas

An MV log may record DML operations that have been performed on a particular base table over any given length of time. Therefore, to perform an incremental refresh on a materialized view, a database system collects, from the MV logs for each of the base tables of the view, the information on DML operations that were performed since the last refresh of the materialized view.

For example, if an MV log is stored in a database table, then the database system may extract the change information that has been recorded in the MV log since the last incremental refresh using one or more SQL expressions. Such SQL expressions may be configured to extract rows from the MV log for changes that have occurred subsequent to a particular time marker denoting the time of the last refresh operation.

To illustrate in the context of MV log 100, a database system may determine that the last incremental refresh of the particular materialized view, which is associated with the base table of MV log 100, was at time marker “0100”. Therefore, the database system may extract those rows from MV log 100 that have time markers after “0100”. In the case of MV log 100, all of the rows record changes that have occurred since the last refresh of the materialized view, except for the row corresponding to row id “001” in column 102. As such, the database system extracts the rows corresponding to row identifiers “002” through “013” (column 102).

A table delta may be formed from the rows that are extracted from an MV log. In a table delta, the extracted rows are organized into groups that facilitate merging the recorded changes with the materialized view. For example, the change information in a table delta may be grouped by row identifier of the changed row in the base table. Such grouping allows the DML operations that have been performed on a particular row of the base table to be considered independently. These groups may also be sequenced by time marker to show the sequence of DML operations over time. A database system may form a table delta for each base table of a materialized view to be refreshed.

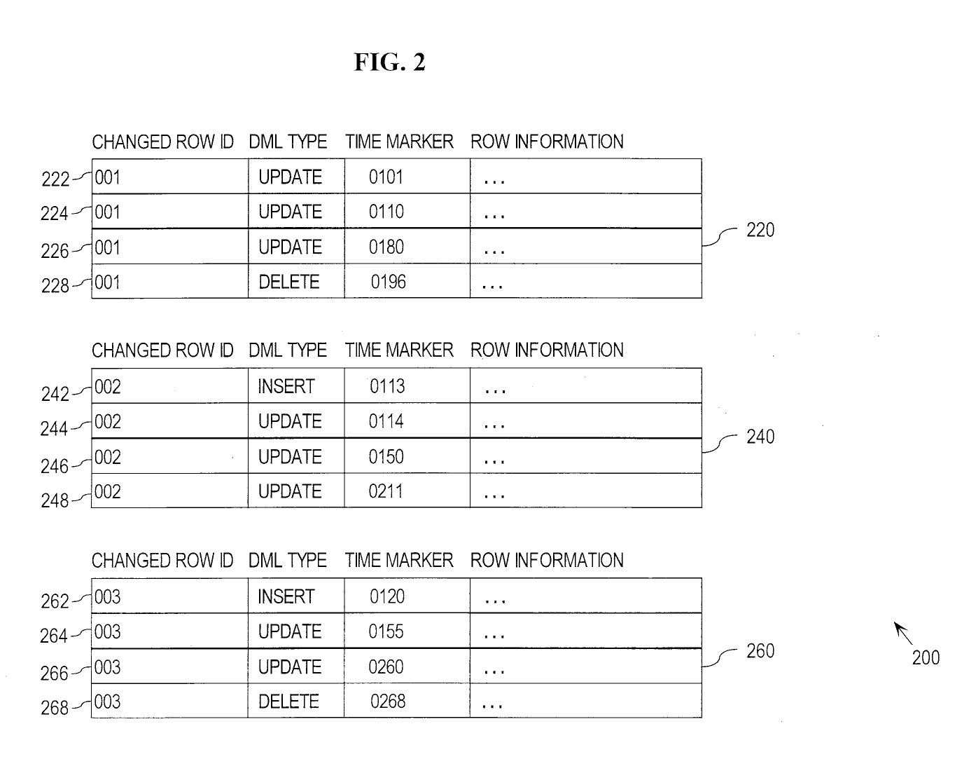

FIG. 2 illustrates a table delta 200 based on change information extracted from MV log 100 of FIG. 1. Table delta 200 includes groups 220, 240, and 260 that correspond to the changes recorded for the row “001”, row “002”, and row “003”, respectively. Also, groups 220, 240, and 260 are sequenced by time marker, such that the order of DML operations in each group show the progression of change of the corresponding base table row. For ease of illustration, other information that may be stored in the rows of table delta 200, e.g., row identifiers from row identifier column 102 of FIG. 1, are not illustrated in table delta 200.

### Refresh SQL Expressions

Based on the table deltas for a materialized view, the database system determines a mechanism with which to apply the DML operations reflected in the table deltas to the materialized view. The database system may configure one or more SQL expressions, termed “refresh expressions”, to merge the changes that are reflected in the table deltas with information in the materialized view.

The process of generating refresh expressions for incrementally refreshing a materialized view is sensitive to the type and quantity of changes that are represented in a table delta. A large quantity and variety of changes to a particular row of a base table results in more complex refresh expressions for the row than the refresh expressions that may be generated for a row of a base table with few changes, or with changes of a single DML type. For purposes of this explanation, an “update” DML operation is considered to be implicitly two different DML operations: a “delete” of the previous row information, and an “insert” of the updated row.

For example, a particular materialized view represents a join between base tables S and T on T.customerId=S.customerId. Table S represents data from a first sales office of a particular company, and table T represents data from a second sales office of the company. Both tables S and T include a “sales” column that represents a dollar amount of sales. Tables S and T also both include a “region” column that indicates the region in which each sale was made, e.g., “west”, “east”, “south”, and “north”. The particular materialized view includes an aggregate SUM function that calculates the sum of sales from both tables S and T for each region.

If a user updates a row in table T to change the region of the row from “west” to “south”, this update is equivalent to both deleting a row from table T with “west” in the region column and inserting a row into table T with the same information as the deleted row, only with “south” in the region column. The MV log for table T, records this change. Therefore, for the next incremental refresh of the particular materialized view, a table delta that is compiled for table T includes the row in the MV log for table T that reflects the described update. The database system managing the particular materialized view generates one or more refresh SQL expressions based at least in part on the table delta for table T. One or more of the refresh expressions operate to subtract the sales amount for the updated row from the sum of sales for the “west” region, and add the sales amount for the updated row to the sum of sales for the “south” region. The refresh expressions may also perform other changes to the particular materialized view.

In a contrasting example, the user only inserts a row into table T that indicates sales for the “west” region. In this example, the database system, after proceeding through the process outlined above, creates one or more refresh expressions for the particular materialized view that add the amount of sales included in the inserted row to the “west” region sales summation. The refresh expressions need not adjust any other of the aggregate values in the particular materialized view.

Thus, as illustrated by the above examples, the refresh expressions generated based on an insert DML operation is much more simple than refresh expressions generated based on an update DML operation.

### Simplifying the DML Sequences

It is possible to simplify the sequences of DML operations recorded for a particular row of a base table before refresh expressions are calculated for the row. In one embodiment of the invention, prior to creating refresh SQL expressions for a particular row, the changes to the row may be physically compressed to translate contiguous “update” type DML operations for a particular row of the base table into a single “update” type DML operation that performs all of the changes of the multiple contiguous updates. For example, the three update operations in rows 222-226 of group 220 may be physically compressed into a single update operation.

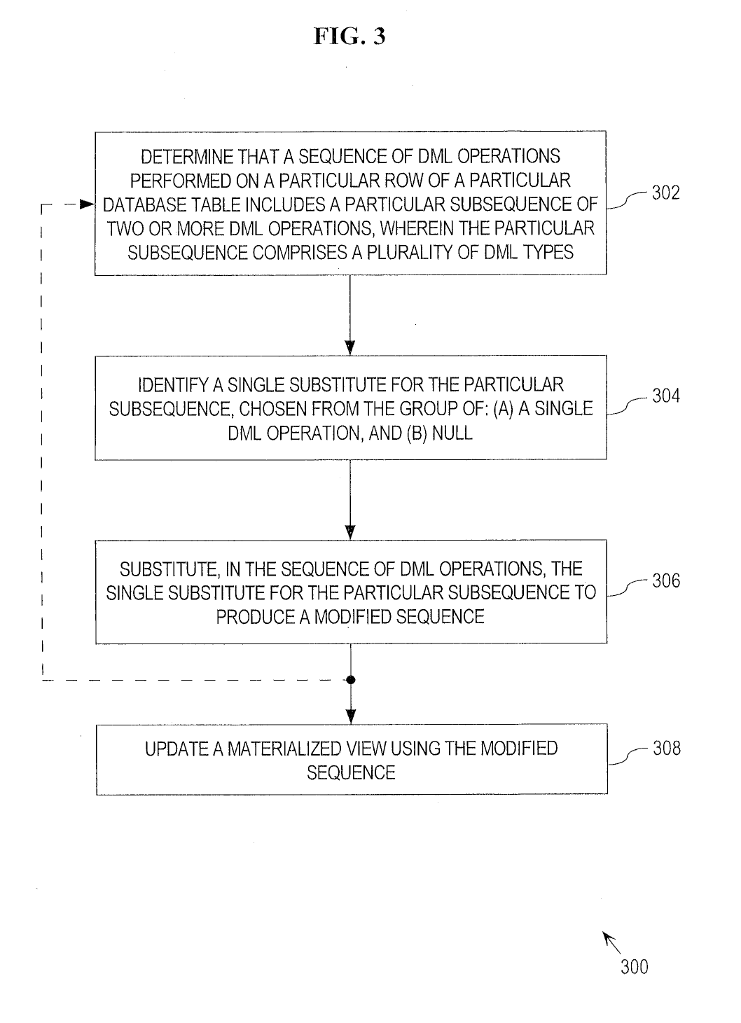

In this embodiment, after physically compressing the DML operations in a table delta, but prior to creating the refresh expressions, sequences of DML operations pertaining to a particular row may be further logically compressed. In another embodiment of the invention, physical compression is not performed on the DML operations in a table delta. In this embodiment, logical compression is performed in the table delta prior to generating refresh expressions based on the table delta. In yet another embodiment of the invention, the operation that compiles the table deltas performs both the physical and logical compressions described herein. FIG. 3 illustrates an example method 300 for logically compressing DML operations in a table delta.

At step 302, it is determined that a sequence of DML operations performed on a particular row of a particular database table includes a particular subsequence of two or more DML operations, wherein the particular subsequence comprises a plurality of DML types. In one embodiment of the invention, the database system identifies the longest subset of a sequence of DML operators that conform to particular patterns of DML operator types. Thus, a database system may identify the longest subsequence of DML operations in a particular sequence that conforms to one of the following patterns: (U+)-D; I-(U+); or I-(U*)-D where U+ represents one or more contiguous “update” type DML operations in the sequence and U* represents zero or more contiguous “update” type DML operations in the sequence. For ease of illustration, these patterns are referred to herein as logical compression patterns.

For example, table delta 200 (FIG. 2) includes a group 220 of DML operations that have been performed on row “001”. The DML operations of group 220 are organized into a sequence based on the time markers of the rows of the group. A database system determines that the sequence of DML operators in the group includes a subsequence of DML operations of the following types: “update” (row 222), “update” (row 224), “update” (row 226), and “delete” (row 228). For ease of illustration, this subsequence of DML operations is represented as U-U-U-D. This subsequence has a plurality of DML types because the DML operations included in the subsequence are of two or more of the following types: (a) insert type; (b) update type; and (c) delete type. The database system identifies subsequence U-U-U-D because the subsequence conforms to the pattern (U+)-D.

At step 304, a single substitute for the particular subsequence is identified, chosen from the group of: (a) a single DML operation, and (b) null. In one embodiment of the invention, the single substitute is the logical equivalent of the particular subsequence. Application of logical equivalent has the same end effect on a row as would application of all of the DML operations in the particular subsequence when these DML operations are applied in order.

Continuing with the previous example, the database system identifies a single substitute that is the logical equivalent of the subsequence of DML operations in group 220. In the case of group 220, the subsequence of U-U-U-D is logically equivalent to a single “delete” type DML operation because application of several “update” type DML operations followed by a “delete” type DML operation has the same end effect on a row as application of a singe “delete” type DML operation. Therefore, the database system identifies a single “delete” type DML operation as the single substitute for the subsequence of group 220.

At step 306, the single substitute is substituted, in the sequence of DML operations, for the particular subsequence to produce a modified sequence. For example, the subsequence of U-U-U-D in group 220 is replaced with the single “delete” type DML operation in the sequence of group 220. In this example, the DML operations in the particular subsequence are the only operations in the sequence of group 220, and therefore the entire sequence of group 220 is replaced by the single substitute.

After step 306, the database system may return to step 302 to further logically compress the sequence of DML operations. In the case of group 220, only a single DML operation remains in the sequence of group 220, and thus, the database system continues to step 308.

At step 308, a materialized view is updated using the modified sequence. For example, the database system generates one or more refresh SQL expressions based on the modified sequence for group 220, or the single “delete” type DML operation. The one or more refresh expressions are applied to the materialized view, which merge the changes to the base table row “001”, which are reflected in group 220, with the materialized view.

Specifically, the database system may create one or more refresh SQL expressions to perform a “delete” type DML operation on the materialized view to delete any information in the materialized view that is associated with row “001”. Furthermore, the one or more refresh SQL expressions may operate to remove information for row “001” from any aggregated information in the materialized view. In one embodiment, refresh SQL expressions may perform DML operations on information pertaining to more than one row in the base table.

Because the database system need only generate refresh expressions for a single “delete” type DML operation for group 220, instead of for several “update” type DML expressions and a “delete” type DML operation, the generated refresh expressions are fewer and/or less complex than would be generated without logical compression. The reduction in complexity is possible because there are less DML operations in the sequence for group 220. Because the refresh expressions are more simple, the refresh expressions are much more efficient to execute.

As a further example, at step 302, a database system determines a particular subsequence of the sequence of DML operations represented in group 240 (FIG. 2), where the subsequence includes two or more DML operations comprising a plurality of DML types. For example, the database system determines the that the sequence of group 240 includes a subsequence of DML operations of the following types: “insert” (row 242), “update” (row 244), “update” (row 246), and “update” (row 248), referred to herein as I-U-U-U. In one embodiment of the invention, this subsequence is identified because it is the longest subsequence that conforms to the logical compression pattern I-(U+).

At step 304, a single substitute is identified for the particular subsequence. In the example of group 240, the single substitute that the database system identifies for subsequence I-U-U-U is a single “insert” type DML operation that operates to insert the row information resulting from the last “update” type DML operation in the subsequence. This single substitute is selected for the subsequence of group 240 because the described “insert” type DML operation is logically equivalent to the subsequence I-U-U-U.

At step 306, the single substitute determined for the subsequence of group 240 is substituted into the sequence represented by group 240 to produce a modified sequence. Like group 220, the subsequence of group 240 includes all of the DML operations in group 240. Therefore, all of the DML operations in group 240 are replaced by the single “insert” type DML operation that is the logical equivalent of the identified subsequence.

At step 308, the materialized view associated with table delta 200 is updated using the modified sequence. For example, the database system generates one or more refresh SQL statements to update the materialized view based on only the single substitute DML operation for group 240. Again, the one or more refresh statements generated based on the single substitute DML statement are less costly to execute than the statements would have been without the logical compression of method 300.

As yet another example, at step 302, a subsequence of DML operations are determined out of the sequence of DML operations in group 260 of table delta 200. The database system searches for a subsequence of group 260 that conforms to a logical compression pattern. For example, group 260 includes rows 262, 264, and 266 that conform to the pattern I-(U+). Also, rows 264, 266, and 268 conform to the pattern (U+)-D. Further, rows 262, 264, 266, and 268 conform to the pattern I-(U*)-D. Because there are multiple subsequences in group 260 that conform to patterns of logical compression, the database system may choose any one of these subsequences within the embodiments of the invention.

In one embodiment of the invention, the database system finds the first identifiable pattern in a sequence, and includes in the subsequence all of the DML operations in the sequence that conform to the pattern. In this embodiment, the database system identifies rows 262, 264, and 268 as the longest subset of DML operations that conforms to the pattern I-(U+).

At step 304, the database system identifies a single “insert” type DML operation that inserts the row information resulting from the last “update” type DML operation of the identified subsequence as the single substitute for the subsequence of group 260. This “insert” type DML operation is the logical equivalent of the identified subset of DML operations from group 260.

At step 306, the database system substitutes the single “insert” type DML operation into the sequence of group 260. Thus, the modified sequence of group 260 is as follows: the single substitute “insert” type DML operation followed by the “delete” type DML operation in row 268, referred to as I-D.

Because not all of the DML operations in group 260 were replaced at step 306, the method may continue to step 302 to identify any other patterns in the sequence of group 260. The database system may base continuation to step 302 from step 306 on the existence of further DML operations in the sequence that conform to logical compression patterns. In the case of the modified sequence of group 260, I-D, the database system determines that DML operations in the modified sequence conform to the logical compression pattern I-(U*)-D. Thus, method 300 returns to step 302.

At step 302, the database system determines that the subsequence I-D, from the modified sequence, is an appropriate subsequence of group 260 because it conforms to a logical compression pattern.

At step 304, the database system identifies a single substitute for the new subsequence I-D. The logical equivalent of an “insert” type DML operation, followed by any number of “update” type DML operations and a “delete” type DML operation is null because the “delete” type DML operation cancels out the insert and update operations. Null indicates no action.

At step 306, the identified subsequence of group 260 is substituted with the single substitute, null, in the sequence of DML operations of group 260. Thus, all of the operations in group 260 are replaced with null. The method continues to step 308 because no DML operations remain in the modified sequence of group 260.

At step 308, the database system does not generate any refresh SQL expressions to perform the operations of group 260 because the entire sequence is replaced with null. As is apparent, no action is much more efficient than performing the insert and update actions on the materialized view and then deleting the information that was inserted and updated, as would have been the case without logical compression.

In another embodiment of the invention, at step 302, the database system identifies a subsequence of the DML operations in a sequence that covers the greatest quantity of DML operations that conform to one of the logical compression patterns. In this embodiment of the invention, the database system identifies all of the rows of group 260 as the subsequence at the first iteration of step 302, which collectively conform to the pattern I-(U*)-D. At step 304, the database system determines that the single substitute for the subsequence is null. At step 306, the subsequence of group 260, which includes all of the DML operations in the group, are replaced with null. Method 300 continues directly to step 308 because no DML operations are left in the modified sequence of group 260. At step 308, no refresh operations are generated for group 260.

Through both physical and logical compression, an incremental refresh of a materialized view is simplified and made more efficient.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

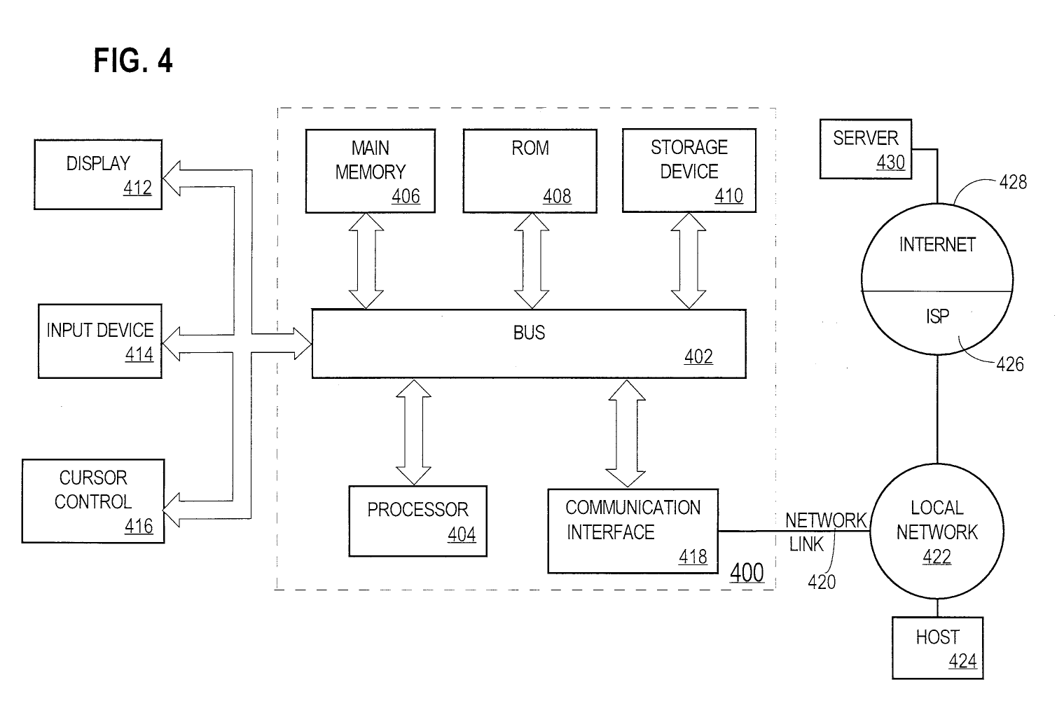

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-executed method comprising:
recording a sequence of data manipulation language (DML) operations performed on a particular row of a particular database table;
determining that the sequence of DML operations includes a particular subsequence of two or more DML operations, wherein the particular subsequence comprises a plurality of DML types;
identifying a single substitute for the particular subsequence, chosen from the group of: (a) a single DML operation, and (b) null;
substituting, in the sequence of DML operations, the single substitute for the particular subsequence to produce a modified sequence; and
updating a materialized view using the modified sequence;
wherein the method is performed by one or more computing devices.

2. The computer-executed method of claim 1, wherein the single substitute is a logical equivalent of the particular subsequence.

3. The computer-executed method of claim 1, wherein:
each DML operation of the sequence of DML operations is associated with respective row information;
the single substitute is a single DML operation; and
first row information that is associated with the single substitute is the same as second row information associated with the last DML operation in the particular subsequence.

4. The computer-executed method of claim 1, wherein:
the single substitute is null; and
the step of updating the materialized view using the modified sequence further comprises not performing any of the DML operations in the particular subsequence.

5. The computer-executed method of claim 1, further comprising:
prior to identifying the single substitute for the particular subsequence, compressing the particular subsequence to eliminate multiple contiguous update-type DML operations.

6. The computer-executed method of claim 1, wherein the plurality of DML types includes at least two of: (a) insert type; (b) update type; and (c) delete type.

7. The computer-executed method of claim 1, wherein the steps are performed as part of a refresh operation on the materialized view by a database management system.

8. The computer-executed method of claim 1, wherein:
the step of determining that the sequence of DML operations includes the particular subsequence of two or more DML operations further comprises determining that the particular subsequence conforms to a pattern of DML operator types chosen from the group:
(a) one or more update type DML operations followed by a delete type DML operation;
(b) an insert type DML operation followed by one or more update type DML operations; and
(c) an insert type DML operation followed by zero or more update type DML operations followed by a delete type DML operation; and
the step of identifying a single substitute for the particular subsequence is based on the pattern of DML operator types to which the particular subsequence conforms.

9. A computer-readable storage medium that stores instructions which, when executed by one or more processors, cause the one of more processors to perform the steps of:
recording a sequence of data manipulation language (DML) operations performed on a particular row of a particular database table;
determining that the sequence of DML operations includes a particular subsequence of two or more DML operations, wherein the particular subsequence comprises a plurality of DML types;
identifying a single substitute for the particular subsequence, chosen from the group of: (a) a single DML operation, and (b) null;
substituting, in the sequence of DML operations, the single substitute for the particular subsequence to produce a modified sequence; and
updating a materialized view using the modified sequence.

10. The computer-readable storage medium of claim 9, wherein the single substitute is a logical equivalent of the particular subsequence.

11. The computer-readable storage medium of claim 9, wherein:
each DML operation of the sequence of DML operations is associated with respective row information;
the single substitute is a single DML operation; and
first row information that is associated with the single substitute is the same as second row information associated with the last DML operation in the particular subsequence.

12. The computer-readable storage medium of claim 9, wherein:
the single substitute is null; and
updating the materialized view using the modified sequence further comprises not performing any of the DML operations in the particular subsequence.

13. The computer-readable storage medium of claim 9, further comprising instructions for compressing the particular subsequence to eliminate multiple contiguous update-type DML operations prior to identifying the single substitute for the particular subsequence.

14. The computer-readable storage medium of claim 9, wherein the plurality of DML types includes at least two of: (a) insert type; (b) update type; and (c) delete type.

15. The computer-readable storage medium of claim 9, wherein the steps are performed as part of a refresh operation on the materialized view by a database management system.

16. The computer-readable storage medium of claim 9, wherein:
determining that the sequence of DML operations includes the particular subsequence of two or more DML operations further comprises determining that the particular subsequence conforms to a pattern of DML operator types chosen from the group:
(a) one or more update type DML operations followed by a delete type DML operation;
(b) an insert type DML operation followed by one or more update type DML operations; and
(c) an insert type DML operation followed by zero or more update type DML operations followed by a delete type DML operation; and
identifying a single substitute for the particular subsequence is based on the pattern of DML operator types to which the particular subsequence conforms.
